(19) United States
(12) Patent Application Publication
(10) Pub. No.: US 2008/0023084 A1
(43) Pub. Date: Jan. 31, 2008

(54) PIPING DESIGN FOR HIGH DENSITY PLASMA PROCESS CHAMBER

(76) Inventors: Ping-Yi Chang, Shanghai (CN); Xiao-Ping Zhang, Shanghai (CN)

Correspondence Address: SINORICA, LLC, 528 FALLSGROVE DRIVE, ROCKVILLE, MD, 20850, US

(21) Appl. No.: 11/692,567

(22) Filed: Mar. 28, 2007

(30) Foreign Application Priority Data
Jul. 27, 2006 (CN) 2006/0029473.X

(51) Int. Cl. F17D 1/00

(52) U.S. Cl. 137/596.13

(57) ABSTRACT

The present invention discloses a piping design for a high density plasma process chamber, wherein an extra pipe is added to between a process chamber and a mass flow controller, and the extra pipe together with a pump is used to drain out the gas, which cannot be monitored by the mass flow controller and survives in a gas injection pipe, lest the remaining gas pollute the deposited film or react with the process gas to induce an explosion in the succeeding deposition process.

### BACKGROUND OF THE INVENTION

1. Field of the Invention

The present invention relates to a piping design for a high density plasma process chamber, whereby the gas remaining in the front piping of a process chamber is pumped out lest a pollutant reaction occur in the succeeding film-deposition process.

2. Description of the Related Art

High Density Plasma (HDP) has a high concentration of plasmarized ions and is usually used in the gap-fill process or the film-deposition process of a high density material. In current VLSI fabrication, HDP is often used in the deposition process of a silicide dielectric layer.

Silicon may come from an inorganic source or an organic source. In addition to non-speciality gases (such as N2 and O2), silane (SiH4) is a speciality gas widely used in the current semiconductor industry. As silane has a very low boiling point of about −112° C., it is in the gaseous state at a normal temperature. However, silane is an explosive poisonous gas. Therefore, silane is not allowed to leak from or remain inside the gas piping in any fabrication process.

There are usually mass flow controllers (MFC) installed in the process piping to monitor the mass flow rates of gases. However, MFC is unlikely to detect a minute gas leakage. In the deposition process of a dielectric film, the leakage or residual of silane implies the danger of explosion and the problem of fabrication failure. Thus, equipment engineers always try to solve such a problem more effectively.

Accordingly, the present invention proposes a piping design for a high density plasma process chamber to solve the problem of the residual gas inside the process piping.

### SUMMARY OF THE INVENTION

The primary objective of the present invention is to provide a piping design for a high density plasma process chamber to effectively solve the problem of the residual gas inside the process piping and prevent the process from failure.

Another objective of the present invention is to provide a piping design for a high density plasma process chamber to fabricate a high-reliability film, reduce the process failures, lower the defective fraction of products, and save the fabrication cost.

To achieve the abovementioned objectives, the present invention proposes a piping design for a high density plasma process chamber, which comprises: a gas injection pipe, a gas exhaust pipe and an extra pipe. The gas injection pipe is connected to a process chamber and used to inject gases to a process chamber, and a mass flow controller is installed on the gas injection pipe. One end of the gas exhaust pipe is connected to the process chamber, and the other end is connected to a pump, and the gas exhaust pipe is used in exhausting gases out of the process chamber. One end of the extra pipe is connected to the gas injection pipe between the process chamber and the mass flow controller, and a third valve is installed at the joint of the extra pipe and the gas injection pipe and used to shunt between the extra pipe and the gas injection pipe. The other end of the extra pipe is connected to the pump.

To enable the objectives, technical contents, characteristics and accomplishments of the present invention to be easily understood, the embodiments of the present invention are to be described in detail in cooperation with the attached drawings below.

### BRIEF DESCRIPTION OF THE DRAWINGS

FIG. 1 is a diagram schematically showing the piping design according to the present invention.

### DETAILED DESCRIPTION OF THE INVENTION

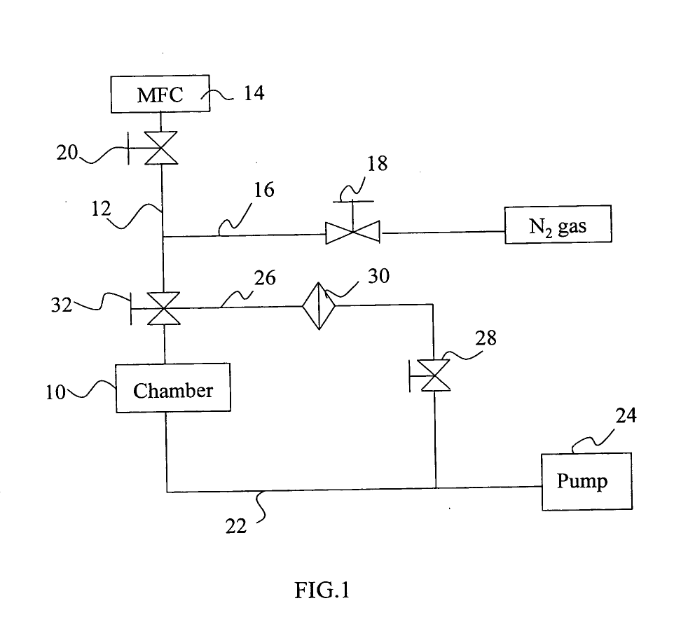

The present invention pertains to a piping design for a high density plasma process chamber. Refer to FIG. 1 a diagram schematically showing the piping design according to the present invention. In FIG. 1, a simpler gas piping for a high density plasma process chamber is used to exemplify the present invention. However, the equivalent modifications or variations realized by the persons skilled in the art, including the modification of valve positions and the layout of the chamber-purge piping, are to be also included within the scope of the present invention.

As shown in FIG. 1, the piping design for a high density plasma process chamber of the present invention comprises: a gas injection pipe 12, a gas exhaust pipe 22 and an extra pipe 26. The gas injection pipe 12 is used to transport a process gas to a process chamber 10, and a mass flow controller (MFC) 14 is installed on the gas inject piping 12 to monitor the mass flow rate of the injected gas. A chamber-purge pipe 16 is connected to the gas injection pipe 12, and a second valve 18 is installed on the chamber-purge pipe 16 and used to control the open/close and the mass flow rate of the chamber-purge gas. A first valve 20 is installed on the gas injection pipe 12 and before the mass flow controller 14 to prevent the chamber-purge gas from flowing adversely to the mass flow controller during the chamber-purge process. Nitrogen is usually adopted as the chamber-purge gas. One end of the gas exhaust pipe 22 is connected to the process chamber 10, and the other end is connected to a pump 24, and the pump 24 is used to pump the reaction-generated gas out of the process chamber 10. One end of the extra pipe 26 is connected to the gas injection pipe 12 between the process chamber 10 and the mass flow controller 14, and a third valve 32 is installed at the joint of the gas injection pipe 12 and the extra pipe 26 and used to shunt between the gas injection pipe 12 and the extra pipe 26. The other end of the extra pipe 26 is connected to the gas exhaust pipe 22, and the connection can be implemented with a T-joint. A fourth valve 28 is installed on the extra pipe 26 and appropriately near the gas exhaust pipe 22 to shunt the gas-pumping paths of the pump 24. Besides, a filter 30 is installed on the extra pipe 26 and used to filter the drained leakage gas.

Before a dielectric layer deposition process is performed, the first valve 20 and the second valve 18 are closed, and the third valve 32 and the fourth valve 28 are opened, and the pump 24 is started to pump out the residual gas (such as silane) surviving inside the gas injection pipe 12. Thereby, the present invention solves the problem that the mass flow controller 14 cannot monitor the minute amount of the leakage gas remaining inside the gas injection pipe 12.

Further, the present invention can also prevent the succeeding dielectric layer deposition process from the explosion of an explosive gas (such as silane) leaking to the pipes.

In summary, the present invention is a piping design for a high density plasma process chamber, which can solve the problem that the mass flow controller cannot monitor the minute amount of the leakage gas remaining in the gas injection pipe and defuse the danger of the fabrication process.

Those described above are the preferred embodiments to exemplify the present invention. However, it is not intended to limit the scope of the present invention. Any equivalent modification and variation according to the shapes, structures, characteristics and spirit implied in the claims of the present invention is to be also included within the scope of the claims of the present invention.

What is claimed is:

1. A piping design for a high density plasma process chamber, comprising:
a gas injection pipe connected to a process chamber and used to transport gas to said process chamber and having a mass flow controller;
a gas exhaust pipe with one end thereof connected to said process chamber and the other end thereof connected to a pump; and
an extra pipe with one end thereof connected to said gas injection pipe between said process chamber and said mass flow controller and the other end thereof connected to said pump, wherein a third valve is installed at the joint of said extra pipe and said gas injection pipe and used to shunt between said extra pipe and said gas injection pipe.

2. The piping design for a high density plasma process chamber according to claim 1 further comprising a chamber-purge pipe.

3. The piping design for a high density plasma process chamber according to claim 2, wherein the gas used in the chamber-purge pipe is nitrogen.

4. The piping design for a high density plasma process chamber according to claim 2, wherein a second valve is installed on said chamber-purge pipe and used to control a mass flow rate of a chamber-purge gas.

5. The piping design for a high density plasma process chamber according to claim 2, wherein said chamber-purge pipe is connected to a portion of said gas injection pipe between said third valve and said mass flow controller.

6. The piping design for a high density plasma process chamber according to claim 5, wherein a first valve is installed between said mass flow controller and said chamber-purge pipe and used to prevent a chamber-purge gas from flowing back to said mass flow controller.

7. The piping design for a high density plasma process chamber according to claim 1, wherein a fourth valve is installed on said extra pipe and used to control a mass flow rate of a gas flowing from said extra pipe to said pump.
